(19) United States
(12) Patent Application Publication
(10) Pub. No.: US 2024/0170990 A1
(43) Pub. Date: May 23, 2024

(54) Management Method for Power Storage Device, Vehicle Control Device, and Vehicle

(71) Applicant: TOYOTA JIDOSHA KABUSHIKI KAISHA, Toyota-shi (JP)

(72) Inventors: Yasuhide KURIMOTO, Kasugai-shi (JP); Tomoyoshi UEKI, Toyota-shi (JP); Yuko TERASAWA, Meguro-ku (JP); Masahiro KAGAMI, Nagoya-shi (JP); Hiroshi YAMASAKI, Nagoya-shi (JP); Kenji ZAITSU, Nisshin-shi (JP); Yoshihiko ENDO, Minato-ku (JP)

(21) Appl. No.: 18/501,093

(22) Filed: Nov. 3, 2023

(30) Foreign Application Priority Data
Nov. 21, 2022 (JP) 2022-185904

(51) Int. Cl. H02J 7/00; B60L 58/10

(52) U.S. Cl. CPC H02J 7/00712; B60L 58/10

(57) ABSTRACT

A management method for a power storage device includes: when energy management by charging or discharging of a power storage device is requested from an aggregator, determining whether or not requested power for charging or discharging exceeds a predetermined value; when the requested power exceeds the predetermined value, if the aggregator having requested is a registered aggregator, performing charging or discharging of the power storage device in accordance with the request; and when the requested power exceeds the predetermined value, if the aggregator having requested is not the registered aggregator, not performing charging or discharging of the power storage device in accordance with the request.

This nonprovisional application is based on Japanese Patent Application No. 2022-185904 filed on Nov. 21, 2022 with the Japan Patent Office, the entire contents of which are hereby incorporated by reference.

### BACKGROUND

### Field

The present disclosure relates to a management method of a power storage device, a vehicle control device, and a vehicle.

### Description of the Background Art

Japanese Patent Application Laid-Open No. 2020-177652 discloses a technique in which a server that manages a lending fee paid by a user for lending a running battery mounted on a vehicle collects a full charge capacity of the battery from the vehicle and lowers the lending fee as the collected full charge capacity decreases.

### SUMMARY

Since the value of the power storage device decreases as the full charge capacity of the power storage device decreases due to deterioration of the power storage device, in the technique described in Japanese Patent Application Laid-Open No. 2020-177652, the lending fee decreases as the full charge capacity decreases. However, in such a technique, the lending fee becomes lower as the power storage device deteriorates. Therefore, the user is not given an incentive to avoid deterioration of the power storage device in using the power storage device. When the power storage device having been lent deteriorates too much, it becomes difficult for a lease provider to reuse the returned power storage device in other applications.

The present disclosure has been made to solve the above-mentioned problem, and an object of the present disclosure is to suppress excessive deterioration of a power storage device.

According to a first aspect of the present disclosure, a management method for a power storage device is provided, the management method including: when energy management by charging or discharging of a power storage device is requested from an aggregator, determining whether or not a requested magnitude of power for the charging or discharging exceeds a predetermined value; when the requested magnitude of the power exceeds the predetermined value, if the aggregator having requested is a registered aggregator, performing charging or discharging of the power storage device in accordance with the request; and when the requested magnitude of the power exceeds the predetermined value, if the aggregator having requested is not the registered aggregator, not performing charging or discharging of the power storage device in accordance with the request.

In a method in which all the aggregators freely perform energy management using the power storage device, there is a possibility that the aggregators may excessively deteriorate the power storage device by the energy management. In particular, rapid charging (high-power charging) and rapid discharging (high-power discharging) are likely to promote deterioration of the power storage device. To address this, in the above method, when the charging power or discharging power for the energy management exceeds the predetermined value, the energy management is permitted only to the known aggregator (i.e., registered aggregator). Since the entity for the energy management involving the rapid charging or rapid discharging is limited to the highly reliable aggregator, it is possible to suppress excessive deterioration of the power storage device.

According to a second aspect of the present disclosure, a vehicle control device is provided. The vehicle control device includes: a processor; and a storage device that stores a program for causing the processor to perform the management method for a power storage device. Moreover, registered identification information of the aggregator is stored in the storage device.

According to the vehicle control device, the above-described management method is preferably performed.

According to a third aspect of the present disclosure, a vehicle that performs the management method for a power storage device is provided. The vehicle includes: a vehicle body; a power storage device mounted on the vehicle body; and a control device that performs the management method with regard to the power storage device. Moreover, the registered aggregator is registered in the control device.

According to the vehicle, the above-described management method is preferably performed.

It should be noted that the vehicle including the power storage device may be an electrically powered vehicle (xEV) that uses electric power as a whole or part of a motive power source. Examples of the xEV include a battery electric vehicle (BEV), a hybrid electric vehicle (HEV), a plug-in hybrid electric vehicle (PHEV) and a fuel cell electric vehicle (FCEV).

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an outline of a management system of a power storage device according to an embodiment of the present disclosure.

FIG. 2 is a diagram for explaining the configuration of the vehicle shown in FIG. 1.

FIG. 3 is a diagram showing a schematic configuration of an energy management system according to an embodiment of the present disclosure.

FIG. 4 is a flowchart showing control for causing a vehicle to execute energy management in the management method of the power storage device according to the embodiment of the present disclosure.

### DESCRIPTION OF THE PREFERRED EMBODIMENTS

Embodiments of the present disclosure will be described in detail with reference to the drawings. In the drawings, the same or corresponding parts are denoted by the same reference numerals, and the description thereof will not be repeated.

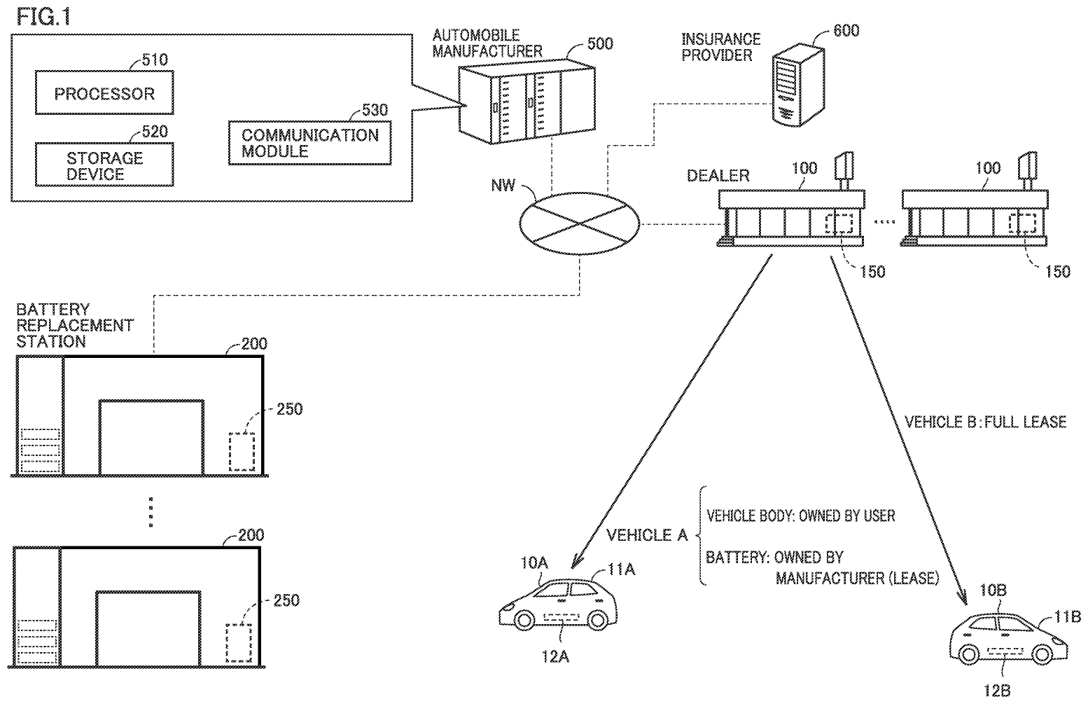

FIG. 1 is a diagram illustrating an outline of a management system of a power storage device according to an embodiment. The management system includes a dealer 100, a battery replacement station (hereinafter referred to as “BSta”) 200, a management center 500, and an insurance server 600.

The management center 500 is a server that provides a lease service for lending a vehicle power storage device. The management center 500 manages information on lease services. The management center 500 belongs to, for example, an automobile manufacturer. In this embodiment, the automobile manufacturer also serves as a lease provider. The insurance server 600 is a server that provides an insurance service. The insurance service is, for example, a service for compensating for deterioration of the power storage device. The insurance server 600, in cooperation with the management center 500, provides an insurance service for the power storage device lent by the lease service.

The automobile manufacturer provides the vehicle manufactured by the automobile manufacturer to a customer (vehicle user) through the dealer 100. The dealer 100 includes a server 150. The dealer 100 lends the power storage device by a plurality of kinds of lease methods. The dealer 100 may lend the power storage device 12A of the vehicle 10A (vehicle A) shown in FIG. 1 to the user by, for example, a partial lease method. In the vehicle A (partially leased vehicle), the vehicle body 11A is owned by the user, and the power storage device 12A is owned by the automobile manufacturer. The dealer 100 may lend the vehicle 10B (vehicle B) shown in FIG. 1 to the user by, for example, the full-lease method. In the vehicle B (full-leased vehicle), all of the vehicles (the vehicle body 11B and the power storage device 12B) are owned by the automobile manufacturer.

In this embodiment, the insurance fee is included in the lease fee (e.g., monthly lease fee) charged by the dealer 100 to the vehicle user. That is, each of the vehicles A and B subscribes to the insurance provided by the insurance server 600. The insurance is applied when power storage devices mounted on these vehicles deteriorate. The insurance service enables, for example, a vehicle user to replace a power storage device with no fee for replacement.

In this embodiment, a plurality of dealers 100 and a plurality of BStas 200 are installed so as to cover the entire jurisdiction area of the management system of the power storage device. The BSta 200 is configured to replace a power storage device for a vehicle. The BSta 200 includes a server 250. The power storage device lent to the vehicle user through the dealer 100 by the vehicle manufacturer is returned from the vehicle user to the BSta 200. In this embodiment, a secondary battery is adopted as the power storage device. Note that the power storage device may be any device as long as it can store power.

The management center 500 includes a processor 510, a storage device 520, and a communication module 530. The communication module 530 is connected to the communication network NW by wire, for example. The management center 500, the insurance server 600, the server 150, and the server 250 are configured to be able to communicate with each other via the communication network NW. The communication network NW is, for example, a wide area network constructed by the Internet and a radio base station.

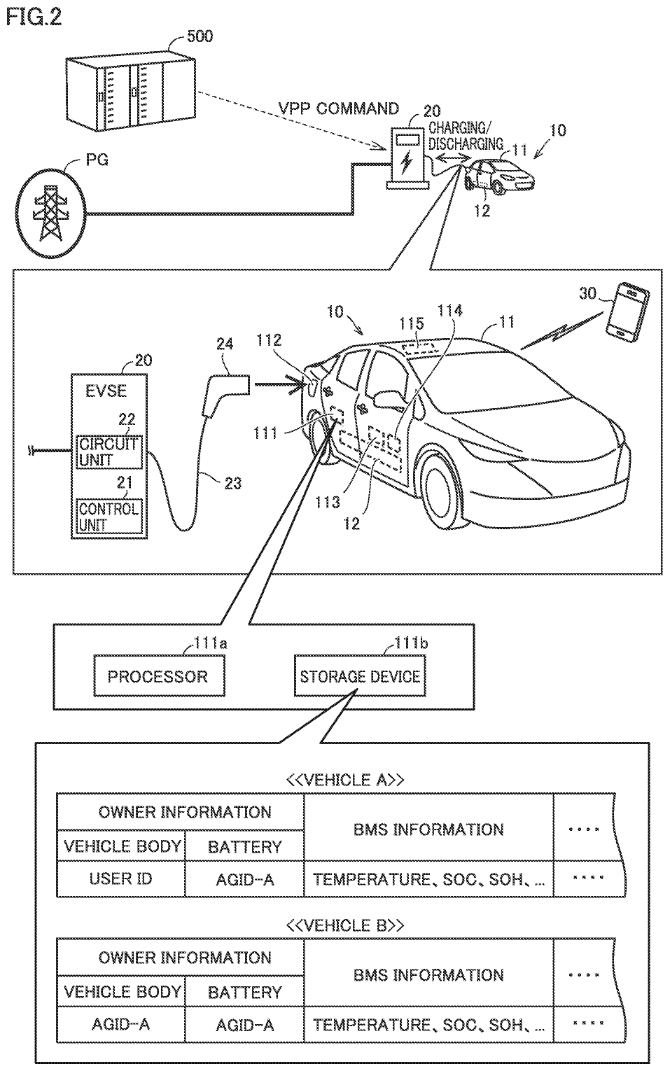

Hereinafter, the vehicle provided by the dealer 100 may be referred to as a “vehicle 10”. The vehicle 10 according to this embodiment is one of the vehicles A and B shown in FIG. 1. FIG. 2 is a diagram illustrating a configuration of the vehicle 10.

Referring to FIG. 2, vehicle 10 includes a vehicle body 11 and a battery 12 mounted on vehicle body 11. The vehicle 10 may be a BEV having no internal combustion engine or a PHEV having an internal combustion engine. As the battery 12, a well-known power storage device for a vehicle (e.g., a lithium ion secondary battery or a nickel hydrogen secondary battery) can be adopted. A plurality of secondary batteries may form a battery assembly. The battery 12 corresponds to an example of the “power storage device” according to the present disclosure.

The vehicle body 11 includes an ECU 111, an inlet 112, a charge/discharge circuit 113, BMS (Battery Management System) 114, and a communication device 115. The vehicle body 11 further includes an HMI (Human Machine Interface) and a position sensor (not shown). The position sensor may utilize GPS (Global Positioning System) to detect the position (e.g., latitude and latitude) of the vehicle 10. The BMS 114 includes various sensors for detecting the state of the battery 12 mounted on the vehicle 10.

The ECU 111 is a computer including a processor 111a and a storage device 111b. The processor 111a includes, for example, a CPU (Central Processing Unit). The storage device 111b stores a program to be executed by the processor 111a. The ECU means an electronic control unit. Power is supplied from an auxiliary battery (not shown) to a control system (including the ECU 111) of the vehicle 10.

The storage device 111b stores owner information about each of the vehicle body 11 and the battery 12. In this embodiment, when the dealer 100 provides the vehicle 10, the dealer 100 writes owner information about the vehicle 10 into each of the storage device of the server 150 and the storage device 111b of the vehicle 10. Thereby, owner information corresponding to the lease contract is written into each storage device.

The owner information includes owner identification information and owner terminal identification information. The identification information of the owner includes information (e.g., legal entity name, identification number, etc.) for identifying the owner. The identification information of the owner's terminal includes information for specifying the owner's terminal (e.g., an identification number, a communication address, etc.). For example, the owner information about the vehicle A indicates that the owner of the vehicle body portion is a vehicle user (terminal is the mobile terminal 30) and the owner of the power storage device is a lease provider (terminal is the management center 500). The owner information about the vehicle B indicates that each owner of the vehicle body portion and the power storage device is a lease provider (terminal is the management center 500).

Although details will be described later, the management center 500 functions as an aggregator. The power storage device (battery 12) of each of the vehicles A and B is provided to the vehicle by a lease. The management center 500 is a terminal of the owner of each of the power storage devices of the vehicles A and B. In the vehicle 10 (vehicles A and B), the identification information (AGID-A) of the management center 500 is stored in the storage device 111b as identification information indicating the terminal of the owner of the battery 12. This means that the management center 500 is registered in the ECU 111 (vehicle control device) of the vehicle 10. In this embodiment, the management center 500 corresponds to a registered aggregator.

The storage device 111b further stores information (hereinafter referred to as “BMS information”) indicating the state (e.g., temperature, current, voltage, SOC, and SOH) of the battery 12 detected by the BMS 114. SOC (State Of Charge) indicates a remaining amount of stored power. SOH (State of Health) indicates the degree of health or deterioration of the power storage device. Examples of SOH include capacity retention and internal resistance. The larger the internal resistance, the greater the degree of deterioration of the power storage device. The lower the capacity retention ratio, the greater the degree of deterioration of the power storage device. The capacity retention ratio corresponds to the ratio of the current capacity to the capacity in the initial state. The capacity of the power storage device corresponds to the amount of power stored in the fully charged state.

EVSE means an electric vehicle supply equipment. The body of the EVSE 20 incorporates a control unit 21 and a circuit unit 22. The EVSE 20 further comprises a charging cable 23 extending outward from the body of the EVSE 20. The charging cable 23 is electrically connected to the circuit unit 22. The control unit 21 includes a processor and a storage device, and is configured to communicate with the management center 500. The circuit unit 22 includes a circuit for supplying power to the vehicle 10 and a circuit for supplying power to the power system PG (reverse power flow).

The inlet 112 is configured such that a connector 24 (tip portion) of the charging cable 23 can be attached/detached. The inlet 112 functions as a charge/discharge port. When the connector 24 of the charging cable 23 connected to the body of the EVSE 20 is connected to the inlet 112 of the vehicle 10 in the parked state, the vehicle 10 is electrically connected to the EVSE 20 (plug-in state). On the other hand, for example, while the vehicle 10 is traveling, the vehicle 10 is not electrically connected to the EVSE 20 (plug-out state). The EVSE 20 further includes a connection detection circuit (not shown) for detecting a state (plug-in state/plug-out state) of the connector 24.

The EVSE 20 and the power system PG are electrically connected to each other. Therefore, the vehicle 10 in the plug-in state is electrically connected to the power system PG. When the vehicle 10 in the plug-in state performs external charging (charging of the battery 12 by power from the outside of the vehicle), power supplied from the power system PG is output to the connector 24 through the circuit unit 22 of the EVSE 20 and input to the inlet 112. The charge/discharge circuit 113 uses the power supplied from the inlet 112 to generate charging power according to an instruction from the ECU 111, and inputs the generated charging power to the battery 12. When the vehicle 10 in the plug-in state performs external power feed (discharge from the battery 12 to the outside of the vehicle), the charge/discharge circuit 113 generates feed power according to an instruction from the ECU 111 using power discharged from the battery 12, and outputs the generated feed power to the inlet 112. Then, the electric power output from the vehicle 10 is supplied to the electric power system PG (reverse power flow) through the circuit unit 22 of the EVSE 20. The charge/discharge circuit 113 generates charging power and feed power using a power conversion circuit (for example, at least one of a DC/DC conversion circuit and an AC/DC conversion circuit).

The communication device 115 includes a communication I/F (interface) for accessing the communication network NW by wireless communication. The communication device 115 may include a TCU (Telematics Control Unit) or DCM (Data Communication Module) that performs wireless communication. The communication device 115 further includes a communication I/F for performing wireless communication with each of the server 250 and the mobile terminal 30. The ECU 111 is configured to communicate with each of the management center 500, the server 250, and the mobile terminal 30 through the communication device 115.

The mobile terminal 30 is carried and operated by a user (a vehicle manager) of the vehicle 10. In this embodiment, a smartphone having a touch panel display is adopted as the mobile terminal 30. The smartphone incorporates a computer and has a speaker function. However, the present disclosure is not limited thereto, and portable game machines, wearable devices, electronic keys, and the like can be adopted as the mobile terminal 30. The identification information (terminal ID) of the mobile terminal 30 is registered in the management center 500 in association with the identification information (vehicle ID) of the corresponding vehicle 10.

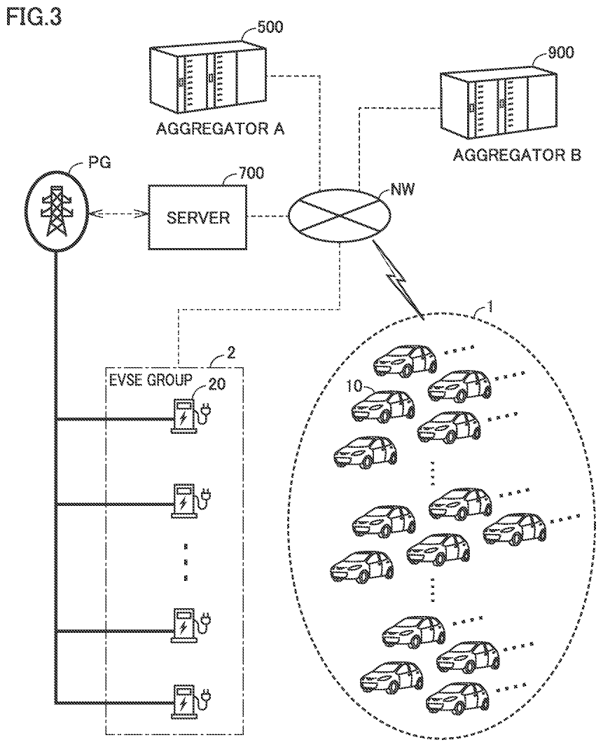

FIG. 3 is a diagram showing a schematic configuration of an energy management system according to this embodiment. Referring to FIG. 3 together with FIG. 1 and FIG. 2, the management center 500 functions as an aggregator and performs energy management of the power system PG in cooperation with the vehicle group 1 and the EVSE group 2. The power system PG is a power network constructed by power transmission and distribution equipment. A plurality of power plants and a plurality of power loads are connected to the power system PG. The server 700 manages information (including supply/demand balance information) about the power system PG.

The management center 500 is configured to be able to communicate with each of the vehicle group 1, EVSE group 2, and server 700 via the communication network NW. The vehicle group 1 includes a plurality of vehicles 10. The EVSE group 2 includes a plurality of EVSEs 20 that receive power from the power system PG. The management center 500 can acquire information (SOC, charging power, discharging power, etc.) about the vehicle 10 and the EVSE 20 by performing wired communication with the vehicle 10 (the vehicle 10 in the plug-in state) connected to the EVSE 20 via the EVSE 20. Further, the vehicle 10 may transmit information to the management center 500 by wireless communication.

Identification information (vehicle ID) of each vehicle included in the vehicle group 1 is registered in the management center 500 in advance. The storage device 520 (FIG. 1) of the management center 500 stores information about each vehicle (vehicle information) in a distinguished manner by vehicle IDs. The vehicle information in the storage device 520 includes the specification of the vehicle, information indicating whether or not the vehicle is in the plug-in state, information on the vehicle in the plug-in state (for example, the BMS information described above), fee information, and incentive information.

The fee information corresponds to information on a lease fee paid by the vehicle user to the automobile manufacturer. The lease fee corresponds to a fee paid by the user to borrow and use the vehicle or the power storage device. The fee information may indicate the unpayment amount of the lease fee for each vehicle user.

The incentive information corresponds to information about an incentive (e.g., a point) paid by the vehicle manufacturer to the vehicle user who performs energy management in response to a request from the vehicle manufacturer. The incentive information may indicate a total value of points acquired by each vehicle user. The points may be exchangeable with money, items, or rights.

The management center 500 causes the vehicle group 1 to execute energy management of the power system PG, for example, in response to a request from the server 700. Vehicle 10 electrically connected to EVSE 20 may function as DER (Distributed Energy Resources) for VPP (virtual power plant). Specifically, the server 700 requests the aggregator to either a first energy management (e.g., a decrease in demand or an increase in supply) that reduces the proportion of power demand to power supply, or a second energy management (e.g., an increase in demand or a decrease in supply) that increases the proportion of power demand to power supply, in order to adjust the balance between supply and demand of the power system PG. Hereinafter, a request for the first or second energy management from the server 700 to the aggregator is also referred to as a “VPP request”. In this embodiment, not only the management center 500 but also the server 900 functions as an aggregator. The server 900 is connected to the communication network NW and receives a VPP request from the server 700.

The aggregator that has received the VPP request requests energy management of the power system PG to the vehicle 10 in the plug-in state by the VPP command. The VPP command is a signal requesting energy management by charging or discharging of the power storage device (for example, the battery 12). The VPP command for the first energy management requests external power feed (discharge) to the vehicle 10 at the designated power. The VPP command for the second energy management requests external charging of the vehicle 10 at the designated power. The VPP command may represent the power on the discharge side by a positive (+) value and the power on the charge side by a negative (−) value. The VPP command may request discharging power or charging power in real time. In this case, the VPP command indicates the instantaneous value of the requested power. The VPP command may also request discharging power or charging power according to a power pattern. In this case, the VPP command indicates a change in power (power pattern) requested in a certain period, and requests the vehicle 10 to make the discharging power or the charging power follow the change in power (power value for each time) specified in the period.

Hereinafter, the management center 500 may be referred to as “aggregator A” and the server 900 may be referred to as “aggregator B”. When the aggregator A or B sends a VPP command to the vehicle 10 in the plug-in state to request energy management of the power system PG, if the vehicle 10 responds to the request, the energy management requested by the aggregator is executed. Each of the plurality of vehicles 10 included in vehicle group 1 may receive VPP commands from both aggregators A and B.

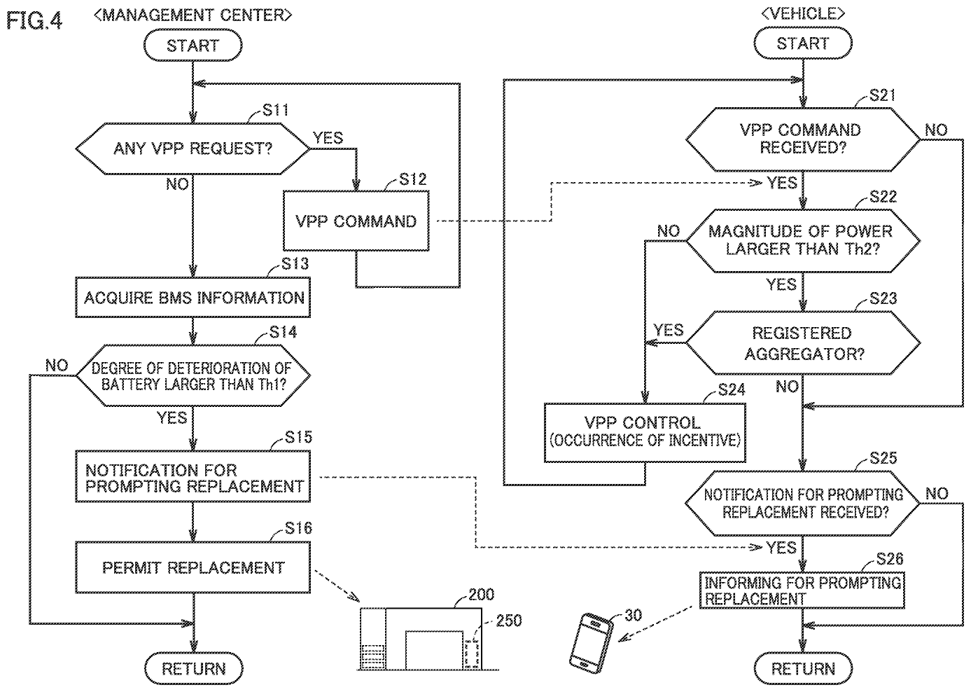

The aggregator A manages the battery 12 of the vehicle 10 so that the battery 12 does not deteriorate too much based on the information acquired from the vehicle 10 (see S13 to S16 in FIG. 4, which will be described later). The aggregator A is registered in the vehicle 10 (see FIG. 2). On the other hand, the aggregator B is not configured to acquire information about the state of the battery 12 from the vehicle 10, and does not manage the battery 12 of the vehicle 10. The aggregator B is not registered in the vehicle 10.

FIG. 4 is a flowchart showing energy management control according to this embodiment. Hereinafter, each step in the flowchart is simply referred to as “S”.

A series of processes (S11 to S16) shown on the left side in FIG. 4 are repeatedly executed by the management center 500. These processes are executed for the vehicle 10 in the plug-in state among the plurality of vehicles 10 included in the vehicle group 1 shown in FIG. 3. When a plurality of vehicles 10 are in the plug-in state, the management center 500 executes a series of processes (S11 to S16) shown in FIG. 4 for each vehicle. Hereinafter, the vehicle 10 (the vehicle A or the vehicle B) in the plug-in state to be processed is referred to as a “target vehicle”.

Referring to FIG. 4 together with FIGS. 1 to 3, in S11, it is determined whether or not the management center 500 has received a VPP request (a discharge request for first energy management or a charge request for second energy management) from the server 700. When the management center 500 does not receive the VPP request (NO in S11), the process proceeds to S13. In this case, the management center 500 does not transmit the VPP command (energy management request) to the target vehicle.

On the other hand, when the management center 500 receives the VPP request (YES in S11), the management center 500 transmits a VPP command (discharge request or charge request) corresponding to the VPP request from the server 700 to the target vehicle in S12. At this time, the management center 500 transmits the identification information (AGID-A) of the aggregator A to the target vehicle together with the VPP command. When the process of S12 is executed, the process returns to the first step (S11). While the server 700 continuously transmits the VPP request to the management center 500, S12 is repeated, and the transmission of the VPP command from the management center 500 to the target vehicle is continuously executed. When the transmission of the VPP request by the server 700 ends, NO is determined in S11, and the process proceeds to S13.

In S13, the management center 500 acquires BMS information (including SOH) indicating the current state of the battery 12 mounted on the target vehicle from the target vehicle. For example, when the management center 500 requests the target vehicle to transmit the BMS information, the target vehicle updates the BMS information in response to the request and transmits the latest BMS information to the management center 500.

In S14, the management center 500 determines whether or not the degree of deterioration of the battery 12 mounted on the target vehicle is greater than a predetermined value (hereinafter referred to as “Th1”). The degree of deterioration of the battery 12 is denoted by SOH (e.g., capacity retention or internal resistance). When the degree of deterioration of the battery 12 is greater than Th1 (YES in S14), the processes of S15 and S16 described below are executed. On the other hand, when the degree of deterioration of the battery 12 is equal to or less than Th1 (NO in S14), the processing skips S15 and S16 and returns to S11.

In S15, the management center 500 notifies the target vehicle that the battery 12 is to be replaced (replacement notification). Subsequently, in S16, the management center 500 acquires the position information of the target vehicle from the target vehicle, and permits one or more BSta 200 (for example, one BSta 200 closest to the current position of the target vehicle or at least one BSta 200 present within a predetermined distance from the current position of the target vehicle) existing around the target vehicle to replace the battery 12 mounted on the target vehicle. Specifically, the management center 500 transmits a replacement permission signal including identification information (vehicle ID) of the target vehicle to one or more BSta 200 existing around the target vehicle. The battery replacement of the target vehicle by the BSta 200 is permitted by the replacement permission signal. The server 250 specifies a vehicle to be replaced based on the vehicle ID included in the received replacement permission signal. When the process of S16 is executed, the process returns to S11.

In the management method of the power storage device according to this embodiment, since the processes of S15 and S16 are executed when the degree of deterioration of the battery 12 becomes large, battery replacement is easy to be performed early. Further, when the degree of deterioration of the battery 12 is greater than Th1 after energy management by charging or discharging of the battery 12 is executed, the processing of S15 and S16 is executed to suppress excessive deterioration of the battery 12.

A series of processes (S21 to S26) shown on the right side in FIG. 4 is repeatedly executed by the ECU 111 of the target vehicle (the vehicle 10 in the plug-in state). In S21, the ECU 111 of the target vehicle determines whether or not the target vehicle has received the VPP command from the aggregator. When the target vehicle has not received the VPP command (NO in S21), the process proceeds to S25.

When the target vehicle receives the VPP command (YES in S21), the ECU 111 determines in S22 whether or not the magnitude of the charging or discharging power requested by the VPP command exceeds a predetermined value (hereinafter referred to as “Th2”). Specifically, when the VPP command indicates the instantaneous value of the requested power, the ECU 111 determines whether or not the instantaneous value (absolute value) exceeds Th2. When the VPP command indicates a requested power pattern (transition of power in a certain period), the ECU 111 determines whether or not the maximum power value (absolute value) in the period exceeds Th2. However, the present disclosure is not limited thereto, and the ECU 111 may determine whether or not the requested power level exceeds Th2 based on the average power value (absolute value) instead of the maximum power value.

When the magnitude of the power requested by the VPP command exceeds Th2 (YES in S22), the ECU 111 determines whether or not the aggregator that transmitted the VPP command is an aggregator registered in the target vehicle in S23. For example, the ECU 111 executes the above determination based on whether or not the identification information (AGID) of the aggregator included in the received VPP command of the target vehicle matches the AGID (for example, identification information indicating the owner of the battery 12 shown in FIG. 2) stored in the storage device 111b of the target vehicle. The matching of both AGIDs means that the aggregator that transmitted the VPP command is registered in the target vehicle. On the other hand, if both AGIDs do not match, this means that the aggregator is not registered in the target vehicle. The fact that no AGID is included in the VPP command means that the aggregator that transmitted the VPP command is not registered in the target vehicle.

When the aggregator having transmitted the VPP command is not registered in the target vehicle (NO in S23), the process proceeds to S25. In this case, charge or discharge (S24) requested by the VPP command is not executed. In this embodiment, if the aggregator that has transmitted the VPP command is the aggregator B, NO is determined in S23.

When the aggregator having transmitted the VPP command is registered in the target vehicle (YES in S23), the process proceeds to S24. In this embodiment, if the aggregator that has transmitted the VPP command is the aggregator A, YES is determined in S23. When the magnitude of the power requested by the VPP command is equal to or less than Th2 (NO in S22), the process proceeds to S24. In this embodiment, when either “NO in S22” or “YES in S23” is satisfied, a requirement (hereinafter, also referred to as “VPP requirement”) that permits energy management requested by the aggregator in the target vehicle is satisfied.

In S24, the ECU 111 controls the charge/discharge circuit 113 so that external charging or external power feed of the battery 12 requested by the VPP command is executed. When the process of S24 is executed, the process returns to S21. While the target vehicle continuously receives the VPP command that satisfies the VPP requirement, S24 is repeated, and external charging or external power feed of the battery 12 corresponding to the VPP command is executed. When the transmission of the VPP command by the aggregator ends, NO is determined in S21, and the process proceeds to S25. After the energy management is completed, the aggregator gives an incentive in accordance with contribution to the user of the target vehicle that has executed the energy management according to the VPP command.

In S25, the ECU 111 determines whether or not the target vehicle has received a replacement notification (S15) from the management center 500. When the target vehicle has received the replacement notification (YES in S25), in S26, the ECU 111 controls the user terminal so that the user terminal (e.g., the mobile terminal 30) of the target vehicle prompts the user to replace the battery 12 by displaying or audio (voice and/or sound). When the informing processing to the user in S26 is executed, the processing returns to the first step (S21). The user terminal is not limited to a mobile terminal, and may be a vehicle-mounted HMI.

The user who is prompted to replace the battery 12 may drive the target vehicle toward the BSta 200. The server 250 of the BSta 200 determines whether or not the battery replacement is permitted based on the identification information of the target vehicle, for example, when requested from the target vehicle to replace the battery 12 by wireless communication. When the server 250 determines that battery replacement for the target vehicle is permitted, the BSta 200 executes replacement of the requested battery 12. BSta 200 may perform battery replacement fully automated. However, BSta 200 does not perform unlicensed battery replacement. The automobile manufacturer may reuse the power storage device returned to the BSta 200 in an application other than the automobile (for stationary use or the like).

As described above, the management method of the power storage device according to this embodiment includes the processes shown in FIG. 4. The ECU 111 includes a processor 111a and a storage device 111b that stores a program that causes the processor 111a to execute the processes of S21 to S26 in FIG. 4. The management method for a power storage device includes: when energy management by charging or discharging of the power storage device is requested from the aggregator, determining (S22) whether or not the requested power for charging or discharging exceeds the predetermined value (Th2); when the requested power exceeds the predetermined value, if the aggregator having requested is a registered aggregator (YES in S23), performing charging or discharging (S24) of the power storage device in accordance with the request; and when the requested power exceeds the predetermined value, if the requested aggregator is not the registered aggregator (NO in S23), not performing charging or discharging (S24) of the power storage device in accordance with the request. In such a method, when the vehicle 10 is requested from an aggregator to perform the energy management by rapid charging (high-power charging) or rapid discharging (high-power discharging), the ECU 111 (control device for the power storage device) permits such energy management only to the known aggregator (i.e., the aggregator A registered in advance). Since the entity for the energy management involving the rapid charging or rapid discharging is limited to the highly reliable aggregator, it is possible to suppress excessive deterioration of the power storage device (battery 12).

In the management method of the power storage device according to this embodiment, the registered aggregator is a terminal (management center 500) of a lease provider. Therefore, the lease provider (the owner of the battery 12) can easily manage the battery 12. For example, the management center 500 may determine a VPP command for the vehicle 10 based on the degree of deterioration of the battery 12 so that the battery 12 does not deteriorate too much.

The management method for a power storage device according to the present embodiment includes: when the requested magnitude of the power is less than the predetermined value (Th2) (NO in S22), performing charging or discharging (S24) of the power storage device in accordance with the request regardless of whether or not the aggregator having requested is the registered aggregator. In such a method, the ECU 111 (control device for the power storage device) of the vehicle 10 permits, without limiting the aggregators, such energy management that is unlikely to deteriorate the power storage device (energy management involving none of the rapid charging and the rapid discharging). This makes it possible to achieve both the suppression of deterioration of the power storage device and the fulfilment of the request in the energy management.

The processing flow shown in FIG. 4 can be changed as appropriate. For example, the order of the processes may be changed or unnecessary steps may be omitted depending on the purpose. Further, the contents of any one of the processes may be changed. For example, S13 to S16 and S25 and S26 may be omitted.

The configuration of the vehicle can be appropriately changed. The vehicle may be configured as being wirelessly chargeable. A vehicle that performs wireless charging may be regarded as being in a state conforming to the “plug-in state” described above when alignment of a power transmitting unit (e.g., a power transmitting coil) on the power supply facility side and a power receiving unit (e.g., a power receiving coil) on the vehicle side is completed. The vehicle may be configured to be capable of executing only one of external charging and external power feed.

The lease method may be only one kind method (for example, partial lease method). In the above embodiment, only the battery is replaced, but the battery pack including the battery and its accessory parts may be collectively replaced. The power storage device used for energy management is not limited to a vehicle battery, and may be a stationary power storage device.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A management method for a power storage device, the management method comprising:
when energy management by charging or discharging of a power storage device is requested from an aggregator, determining whether or not a requested magnitude of power for the charging or discharging exceeds a predetermined value;
when the requested magnitude of the power exceeds the predetermined value, if the aggregator having requested is a registered aggregator, performing charging or discharging of the power storage device in accordance with the request; and
when the requested magnitude of the power exceeds the predetermined value, if the aggregator having requested is not the registered aggregator, not performing charging or discharging of the power storage device in accordance with the request.

2. The management method for a power storage device according to claim 1, wherein
the power storage device is provided to a vehicle by a lease, and
the registered aggregator is a terminal of an owner of the power storage device.

3. The management method for a power storage device according to claim 1, further comprising:
when the requested magnitude of the power is less than the predetermined value, performing charging or discharging of the power storage device in accordance with the request regardless of whether or not the aggregator having requested is the registered aggregator.

4. A vehicle control device comprising:
a processor; and
a storage device that stores a program for causing the processor to perform the management method for a power storage device according to claim 1, wherein
identification information of the registered aggregator is stored in the storage device.

5. A vehicle that performs the management method for a power storage device according to claim 1, the vehicle comprising:
a vehicle body;
a power storage device mounted on the vehicle body; and
a control device that performs the management method with regard to the power storage device, wherein
the registered aggregator is registered in the control device.
